(19) United States
(12) Patent Application Publication
(10) Pub. No.: US 2017/0003621 A1
(43) Pub. Date: Jan. 5, 2017

(54) Combined rotating toner feeding device

(71) Applicant: Beijing Xinchen Office Equipment Co.,LTD, Beijing (CN)

(72) Inventors: Ruxu Wang, Beijing (CN); Bo Chen, Beijing (CN)

(73) Assignee: Beijing Xinchen Office Equipment Co.,LTD

(21) Appl. No.: 14/880,193

(22) Filed: Oct. 10, 2015

(30) Foreign Application Priority Data
Jul. 2, 2015 (CN) 201520464825.9

(51) Int. Cl. G03G 15/08

(52) U.S. Cl. CPC G03G 15/0891; G03G 15/0865

(57) ABSTRACT

An improved combined rotating toner feeding device, includes: a cartridge body; a back cover provided on a bottom of the cartridge body; and a back cover sealing ring provided between the cartridge body and the back cover; wherein a driving gear is provided on a top portion of the cartridge body; two gear sealing rings are respectively provided on two ends of the driving gear; a cross body is inserted in an internal side of the driving gear; a feeding toner stirring blade is fixed on an external side of the cross body; a cartridge top cover is provided on a top portion of the cartridge body; a snap cover is buckled on a top portion of the cartridge top cover; a sealing strip is provided on a bottom of the snap cover.

### CROSS REFERENCE OF RELATED APPLICATION

The present application claims priority under 35 U.S.C. 119(a-d) to CN201520464825.9, filed Jul. 2, 2015.

### BACKGROUND OF THE PRESENT INVENTION

Field of Invention

The present invention relates to a photoprint accessory, and more particularly to an improved combined rotating toner feeding device.

Description of Related Arts

Toner cartridge is a device provided in a copier or printer for driving toner. The conventional toner cartridges are not smooth in toner discharge, which causes more toner are wasted.

### SUMMARY OF THE PRESENT INVENTION

A technical solution to be solved by the present invention is to provide an improved combined rotating toner feeding device which is capable of overcoming shortcomings in the conventional art and improving smoothness of toner discharge of the conventional toner cartridge.

Accordingly, in order to solve the problem mentioned above, a technical solution provided by the present invention is as follows.

An improved combined rotating toner feeding device comprises:

a cartridge body;

a back cover provided on a bottom of the cartridge body; and

a back cover sealing ring provided between the cartridge body and the back cover;

wherein a driving gear is provided on a top portion of the cartridge body;

two gear sealing rings are respectively provided on two ends of the driving gear;

a cross body is inserted in an internal side of the driving gear;

a feeding toner stirring blade is fixed on an external side of the cross body;

a cartridge top cover is provided on a top portion of the cartridge body;

a snap cover is buckled on a top portion of the cartridge top cover;

a sealing strip is provided on a bottom of the snap cover;

a chip is fixed on a top portion of the snap cover via a chip fixing frame;

a toner discharging cover is provided on a side face of the cartridge top cover;

a toner discharging sealing cover is provided on a bottom portion of the toner discharging cover;

a toner discharge sliding blade is slidably provided between the toner discharging cover and the cartridge top cover;

an O-shaped ring baffle plate is provided on an internal side of the toner discharge sliding blade; and

two toner discharging cover sealing rings are respectively provided on a top portion and the bottom portion of the toner discharging cover.

Preferably, four bosses are uniformly provided on an outlet of the cartridge body.

Preferably, a diameter of each of the bosses is 3 mm and a height thereof is 1 mm.

Preferably, each of the two toner discharging cover sealing rings comprises a first rubber layer and a second rubber layer connected on an external side of the first rubber layer via a double sided adhesive tape.

Beneficial effects brought about by adopting the technical solution mentioned above are as follows. The improved combined rotating toner feeding device of the present invention has a compact structure. By combining the cross body and the feeding toner stirring blade, an amount of the toner is not decreased while flowing from the cartridge to an opening due to a gap therebetween, and thus effectively improves toner feeding efficiency. The driving gear is used for driving the cross body and the feeding toner stirring blade to rotate, so as to achieve flowing the toner via the toner discharging cover. End surfaces of the driving gear adopt an injection technique, which improves smoothness and durability of the driving gear. The boss is capable of effectively decreasing friction force of the cartridge body. The toner discharging cover sealing ring not only is capable of effectively decreasing sliding resistance of the toner discharge sliding blade, but also has an excellent sealing effect. The improved combined rotating toner feeding device of the present invention has characteristics of compact structure, smooth toner discharge and high toner utilization ratio.

### BRIEF DESCRIPTION OF THE DRAWINGS

FIG. 1 is a structural diagram of a top portion of a cartridge body according to a preferred embodiment of the present invention.

FIG. 2 is a structural diagram of a bottom portion of a cartridge body according to the preferred embodiment of the present invention.

FIG. 3 is an external structural diagram of an improved combined rotating toner feeding device after assembly according to the preferred embodiment of the present invention.

Reference numbers of elements in the drawings are as follows. 1-cartridge body; 2-back cover; 3-back cover sealing ring; 4-driving gear; 5-gear sealing ring; 6-cross body; 7-feeding toner stirring blade; 8-cartridge top cover; 9-snap cover; 10-sealing strip; 11-chip fixing frame; 12-chip; 13-toner discharging cover; 14-toner discharging sealing cover; 15-toner discharge sliding blade; 16-O-shaped ring baffle plate; 17-toner discharging cover sealing ring; 18-boss; 19-first rubber layer; 20-double sided adhesive tape; 21-second rubber layer.

### DETAILED DESCRIPTION OF THE PREFERRED EMBODIMENT

All standard parts utilized in the present invention can be purchased from the market. Special shaped parts can be customized according to the description of the specification and the accompany drawings. Specific connection modes of each part all adopts mature common means in the conventional art such as bolt, rivet, weld, paste and etc, which is no longer described here in detail.

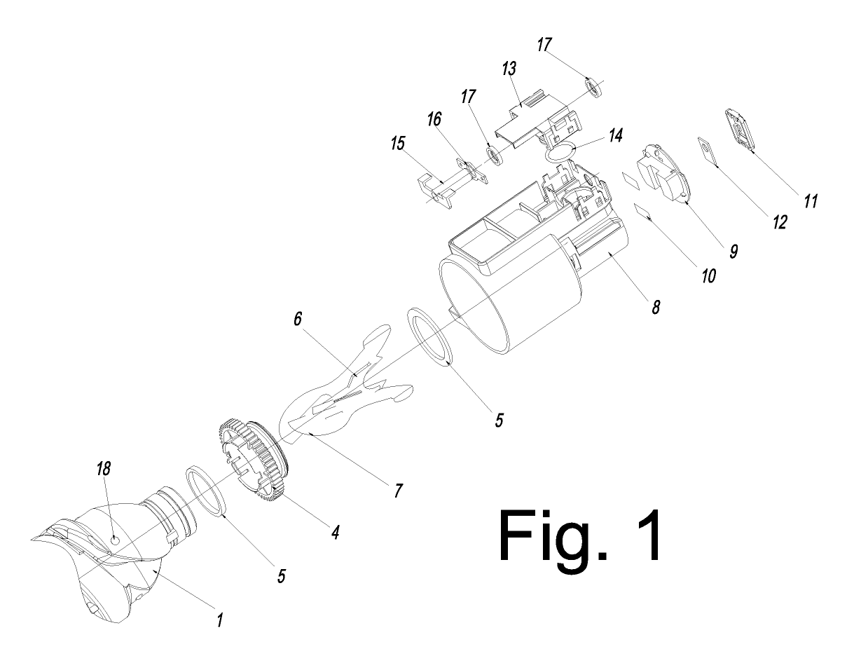

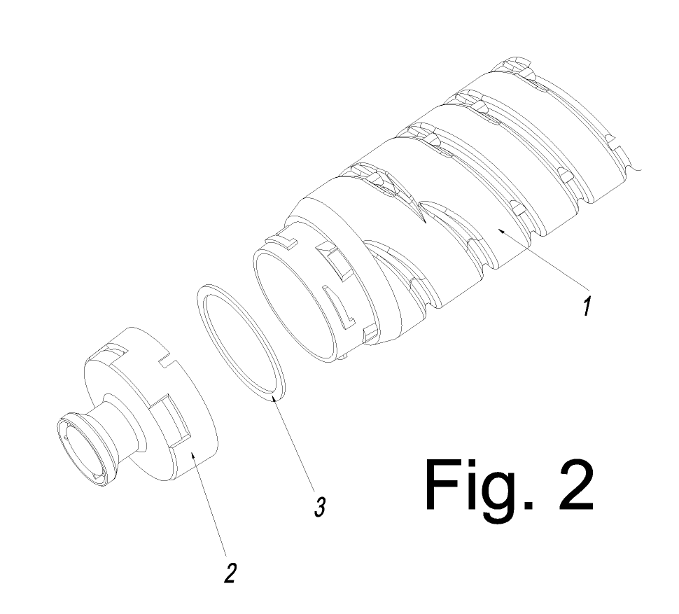

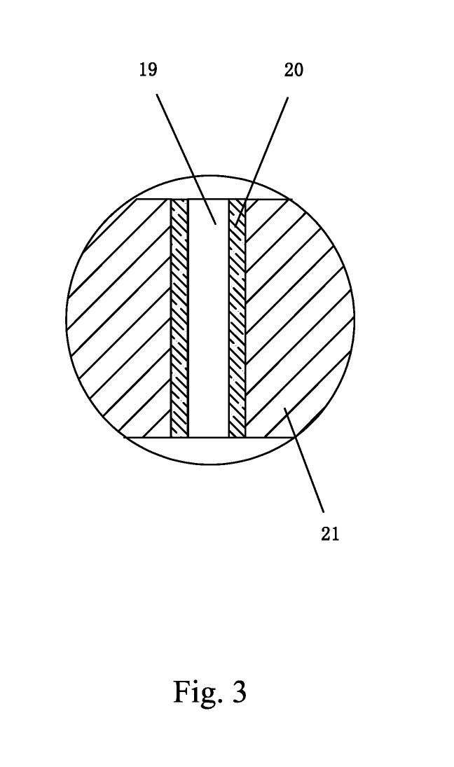

Referring to FIGS. 1-3, according to a preferred embodiment of the present invention, an improved combined rotating toner feeding device comprises a cartridge body 1, a back cover 2 provided on a bottom of the cartridge body 1; and a back cover sealing ring 3 provided between the cartridge body 1 and the back cover 2; wherein a driving gear 4 is provided on a top portion of the cartridge body 1; two gear sealing rings 5 are respectively provided on two ends of the driving gear 4; a cross body 6 is inserted in an internal side of the driving gear 4; a feeding toner stirring blade 7 is fixed on an external side of the cross body 6; a cartridge top cover 8 is provided on a top portion of the cartridge body 1; a snap cover 9 is buckled on a top portion of the cartridge top cover 8; a sealing strip 10 is provided on a bottom of the snap cover 9; a chip 12 is fixed on a top portion of the snap cover 9 via a chip fixing frame 11; a toner discharging cover 13 is provided on a side face of the cartridge top cover 8; a toner discharging sealing cover 14 is provided on a bottom portion of the toner discharging cover 13; a toner discharge sliding blade 15 is slidably provided between the toner discharging cover 13 and the cartridge top cover 8; an O-shaped ring baffle plate 16 is provided on an internal side of the toner discharge sliding blade 15; and two toner discharging cover sealing rings 17 are respectively provided on a top portion and the bottom portion of the toner discharging cover 13. Four bosses 18 are uniformly provided on an outlet of the cartridge body 1. A diameter of each of the bosses 18 is 3 mm and a height thereof is 1 mm. Each of the two toner discharging cover sealing rings 17 comprises a first rubber layer 19 and a second rubber layer 21 connected on an external side of the first rubber layer 19 via a double sided adhesive tape 20.

According the preferred embodiment of the present invention, by combining the cross body 6 and the feeding toner stirring blade 7, the improved combined rotating toner feeding device is capable of effectively improving toner feeding efficiency. The driving gear 4 is used for driving the cross body 6 and the feeding toner stirring blade 7 to rotate, so as to achieve flowing the toner via the toner discharging cover 13. End surfaces of the driving gear 4 adopt an injection technique, which improves smoothness and durability of the driving gear. The boss 18 is capable of effectively decreasing friction force of the cartridge body 1. The toner discharging cover sealing ring 17 not only is capable of effectively decreasing sliding resistance of the toner discharge sliding blade 15, but also has an excellent sealing effect. The improved combined rotating toner feeding device according to the preferred embodiments of the present invention has characteristics of compact structure, smooth toner discharge and high toner utilization ratio.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1. An improved combined rotating toner feeding device, comprising:
a cartridge body (1);
a back cover (2) provided on a bottom of the cartridge body (1); and
a back cover sealing ring (3) provided between the cartridge body (1) and the back cover (2);
wherein a driving gear (4) is provided on a top portion of the cartridge body (1);
two gear sealing rings (5) are respectively provided on two ends of the driving gear (4);
a cross body (6) is inserted in an internal side of the driving gear (4);
a feeding toner stirring blade (7) is fixed on an external side of the cross body (6);
a cartridge top cover (8) is provided on a top portion of the cartridge body (1);
a snap cover (9) is buckled on a top portion of the cartridge top cover (8);
a sealing strip (10) is provided on a bottom of the snap cover (9);
a chip (12) is fixed on a top portion of the snap cover (9) via a chip fixing frame (11);
a toner discharging cover (13) is provided on a side face of the cartridge top cover (8);
a toner discharging sealing cover (14) is provided on a bottom portion of the toner discharging cover (13);
a toner discharge sliding blade (15) is slidably provided between the toner discharging cover (13) and the cartridge top cover (8);
an O-shaped ring baffle plate (16) is provided on an internal side of the toner discharge sliding blade (15); and
two toner discharging cover sealing rings (17) are respectively provided on a top portion and the bottom portion of the toner discharging cover (13).

2. The improved combined rotating toner feeding device, as recited in claim 1, wherein four bosses (18) are uniformly provided on an outlet of the cartridge body (1).

3. The improved combined rotating toner feeding device, as recited in claim 2, wherein a diameter of each of the bosses (18) is 3 mm and a height thereof is 1 mm.

4. The improved combined rotating toner feeding device, as recited in claim 1, wherein each of the two toner discharging cover sealing rings (17) comprises a first rubber layer (19) and a second rubber layer (21) connected on an external side of the first rubber layer (19) via a double sided adhesive tape (20).

5. An improved combined rotating toner feeding device, comprising:
a cartridge body (1);
a back cover (2) provided on a bottom of the cartridge body (1); and
a back cover sealing ring (3) provided between the cartridge body (1) and the back cover (2);
wherein a driving gear (4) is provided on a top portion of the cartridge body (1);
two gear sealing rings (5) are respectively provided on two ends of the driving gear (4);
a cross body (6) is inserted in an internal side of the driving gear (4);
a feeding toner stirring blade (7) is fixed on an external side of the cross body (6);
a cartridge top cover (8) is provided on a top portion of the cartridge body (1);
a snap cover (9) is buckled on a top portion of the cartridge top cover (8);
a sealing strip (10) is provided on a bottom of the snap cover (9);
a chip (12) is fixed on a top portion of the snap cover (9) via a chip fixing frame (11);
a toner discharging cover (13) is provided on a side face of the cartridge top cover (8);
a toner discharging sealing cover (14) is provided on a bottom portion of the toner discharging cover (13);
a toner discharge sliding blade (15) is slidably provided between the toner discharging cover (13) and the cartridge top cover (8);
an O-shaped ring baffle plate (16) is provided on an internal side of the toner discharge sliding blade (15); and
two toner discharging cover sealing rings (17) are respectively provided on a top portion and the bottom portion of the toner discharging cover (13);
wherein four bosses (18) are uniformly provided on an outlet of the cartridge body (1);
a diameter of each of the bosses (18) is 3 mm and a height thereof is 1 mm; and
each of the two toner discharging cover sealing rings (17) comprises a first rubber layer (19) and a second rubber layer (21) connected on an external side of the first rubber layer (19) via a double sided adhesive tape (20).

6. The improved combined rotating toner feeding device, as recited in claim 1, wherein the driving gear is used for driving the cross body and the feeding toner stirring blade to rotate, so as to achieve flowing the toner via the toner discharging cover; end surfaces of the driving gear adopt an injection technique, which improves smoothness and durability of the driving gear.

7. The improved combined rotating toner feeding device, as recited in claim 6, wherein the driving gear is used for driving the cross body and the feeding toner stirring blade to rotate, so as to achieve flowing the toner via the toner discharging cover; end surfaces of the driving gear adopt an injection technique, which improves smoothness and durability of the driving gear.
